(19) United States
(12) Patent Application Publication
(10) Pub. No.: US 2009/0210829 A1
(43) Pub. Date: Aug. 20, 2009

(54) DEVICE FOR CONTROLLING A GRAPHICAL POINTER ON A WORK AREA OF A COMPUTER DISPLAY

(75) Inventor: Fabrizio Giacomelli, Foggia (IT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MEDIAVOICE S.R.L., Foggia (IT)

(21) Appl. No.: 12/278,361

(22) PCT Filed: Feb. 2, 2007
(86) PCT No.: PCT/IT07/00071

§ 371 Date: Dec. 22, 2008

(30) Foreign Application Priority Data
Feb. 6, 2006 (IT) RM2006A000059

(51) Int. Cl. G06F 3/033; G06F 3/048

(52) U.S. Cl. 715/858; 715/856

(57) ABSTRACT

The present invention concerns a device for controlling at least one graphical pointer on a work area of a computer display, comprising at least one element, corresponding to said at least one graphical pointer, capable to move on an area included in a tablet, and sensor means capable to detect the position of said at least one element in said area of the tablet, a one-to-one relationship existing between the position of said at least one element within said area of the tablet and the position of said at least one graphical pointer on said work area of the display, wherein said at least one element is movable by means of motion means according to at least two degrees of freedom with respect to the tablet, and in that the means for sensing the position of said at least one element sends one or more signals to processing means capable to process them for determining the position of said at least one graphical pointer corresponding one-to-one with the position of said at least one element. The present invention further concerns a computer incorporating such controlling device.

The present invention concerns a device for controlling a graphical pointer on a work area of a computer display, that allows in a simple, precise, and reliable way the graphical pointer to be moved on the work area, being particularly advantageous, in some embodiments thereof, when the work area of the computer display is provided with selectable graphical elements, still more in particular for blind or visually impaired users.

The present invention further concerns the related controlling method and a computer incorporating the controlling device.

It is known that computers are provided with a display allowing users to verify their interactions with the same computer. In particular, computers are provided with a set of programs, called operating system, allowing an optimised control of the computer electronic resources in a way completely transparent to the user, receiving data and/or instructions, through a data entry device, e.g. a keyboard, and outputting data and/or instruction request through the display.

Presently, most part of computers are provided with an operating system provided with a graphical user interface, or GUI, onto which a graphical pointer is movable under control of, usually electro-mechanical or electro-optical, pointing means transmitting the related signals for controlling position and/or movement of the graphical pointer and one or more selection signals to the computer.

Presently more diffused GUIs consist in a so-called “window” interface, wherein each window is an interaction interface of a specific application program comprising, besides displayed and not user-modifiable data, some selectable graphical elements allowing the user to interact with the same application program. By way of example, but not by way of limitation, such selectable graphical elements may be command menu bars, window scrolling bars, graphical buttons, selectable option boxes or checkboxes, groups of alternatively selectable option boxes, groups of simultaneously selectable option boxes, textboxes, hypertext connections or links, icons.

The several windows of a GUI may be alternatively enabled to interact and, when disabled, may be graphically represented by a corresponding icon. When interaction with an application program is enabled, the related window becomes the work area through which the user may interact with the program by means of the graphical pointer (besides the keyboard). In particular, the selection of a selectable graphical element within the active window, that constitutes the work area, occurs through superimposition of the graphical pointer on the selectable element and simultaneous generation, by the pointing means, of a corresponding selection signal.

In the following explicit reference will be made to a computer provided with an operating system provided with window GUI. However it should be considered that the pointing device according to the invention may be also applied to other types of graphical user interface comprising graphical elements selectable through a graphical pointer controlled by pointing means.

The pointing means comprises a pointing device, connected to the computer, that generates signals for controlling position and/or movement of the graphical pointer, through generation of suitable control signals, and capable to generate one or more selection signals, usually through one or more selection buttons operated by the user. In particular, the user is capable to control position and movement of the graphical pointer on the display through a two- or three-dimensional physical manipulation of the device.

Present pointing devices are classifiable in two categories: a first category of pointing devices controls graphical pointer position through the position of a movable element manipulated by the user within a predetermined area corresponding to the computer display, so that each point of the area within which the movable element can be moved one-to-one corresponds to a display point (e.g., graphics tablets and light pens belong to this category); a second category of pointing devices is that of the so-called “relative” control devices, which control graphical pointer movement, by making a control of the variation of its position relative to the move starting point.

Among the pointing devices, those commonly known as “mouses” (rolling ball or electro-optical ones) and those applied to portable computers, namely touchpads, comprising a small plane surface that is electronically sensitive to the touch by an object, are the most diffused.

The pointing devices are wired or wireless (e.g. infrared) connected to computer for transmitting signals for controlling the graphical pointer.

However, conventional pointing devices have some drawbacks.

First of all, the need exists that the user acquires a certain familiarity with the pointing device, that is not immediately easily operatable by inexpert users.

Moreover, other drawbacks are mainly due to the fact that the user may verify the effect of his/her device manipulation only by observing on the display the resulting position and/or movement.

Considering that the work areas of present graphical interfaces are often very rich of selectable elements (e.g., consider web pages listing links to other web pages), such visual interaction may be not sufficient even for non impaired users, while it is absolutely not usable by blind or visually impaired users.

In this regard, today blind users use both specific softwares aiding in the use of computer (display reading programs), and particular electronic devices translating contents of computer display into Braille language thanks to transducing devices.

Softwares allow audio delivery of contents of display and active work areas thereof (such as for instance an interface of a “browser” program), for instance permitting browsing among links thanks to directional keys of the keyboard, and speech synthesizing the text content of a selected link. JAWS® and outSPOKEN are the most diffused softwares of this type.

However, if a blind user is on a web page which he/she knows, he/she needs to sequentially scroll all the links through the directional keys before arriving at the desired one.

Electronic devices intended for blind users consist in systems offering a transduction of the text displayed on the display.

However, such transduction is typically sequential and cannot be particularly quick.

Moreover, both speech synthesizing softwares and electronic transducing devices are complex and expensive.

It is therefore an object of the present invention to provide a device for controlling a graphical pointer, that allows in a simple, precise, and reliable way the graphical pointer to be moved.

It is still an object of the present invention to provide an interactive device for controlling a graphical pointer that ensures a greater user interaction.

It is a more particular object of the present invention to provide such an interactive device that is advantageous for blind or visually impaired users.

It is specific subject matter of the present invention a device for controlling at least one graphical pointer on a work area of a computer display, comprising at least one element, corresponding to said at least one graphical pointer, capable to move on an area included in a tablet, and sensor means capable to detect the position of said at least one element in said area of the tablet, a one-to-one relationship existing between the position of said at least one element within said area of the tablet and the position of said at least one graphical pointer on said work area of the display, characterized in that said at least one element is movable by means of motion means according to at least two degrees of freedom with respect to the tablet, and in that the means for sensing the position of said at least one element sends one or more signals to processing means capable to process them for determining the position of said at least one graphical pointer corresponding one-to-one with the position of said at least one element.

Further embodiments of the controlling device are defined in the attached dependent claims 2-46.

It is still specific subject matter of the present invention a method for controlling at least one graphical pointer on a work area of a computer display, characterized in that it comprises the following steps:

A. receiving, from sensor means of a device for controlling at least one graphical pointer on a work area of a computer display as previously described, one or more first signals indicative of the position of said at least one element in said area of the tablet;

B. processing said one or more first signals for determining the position of said at least one graphical pointer corresponding one-to-one with the position of said at least one element.

Further embodiments of the controlling method are defined in the attached dependent claims 48-71.

It is always specific subject matter of the present invention a computer, characterized in that it incorporates a device for controlling at least one graphical pointer on a work area of a computer display as previously described.

The present invention will now be described, by way of illustration and not by way of limitation, according to its preferred embodiments, by particularly referring to the Figures of the enclosed drawings, in which:

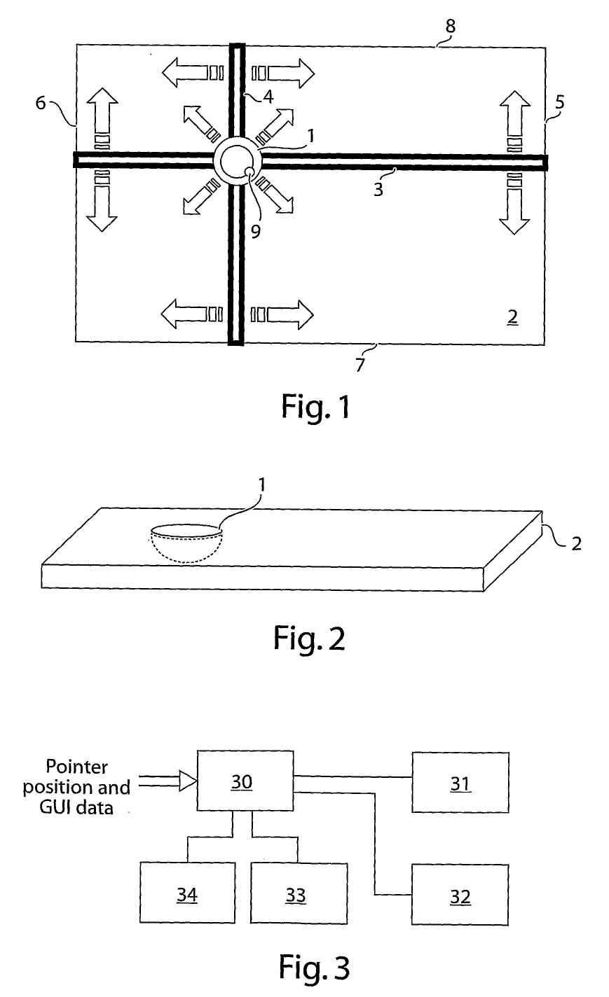

FIG. 1 schematically shows a top plan view of a preferred embodiment of the device according to the invention;

FIG. 2 shows a perspective view of the device of FIG. 1;

FIG. 3 schematically shows the architecture of the components of the device of FIG. 1;

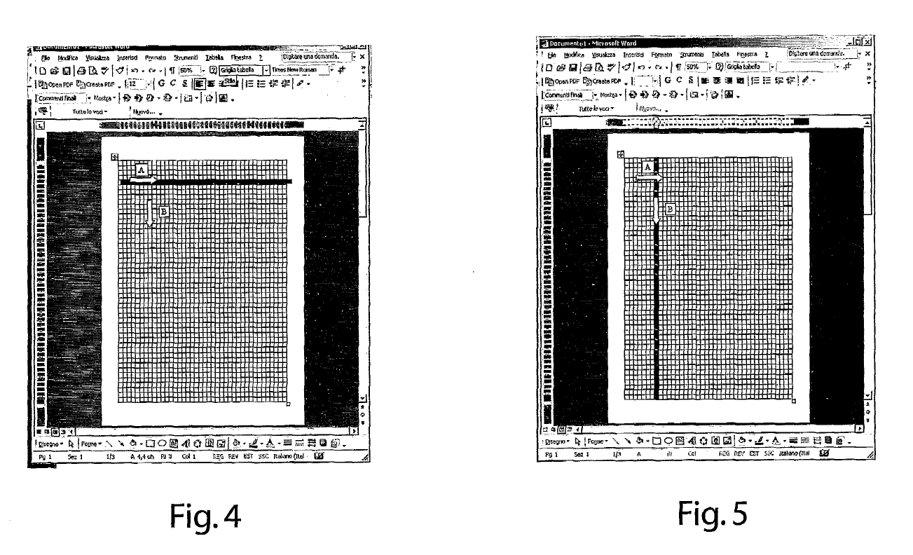

FIG. 4 shows a first graphical interface with which the device of FIG. 1 interacts;

FIG. 5 shows a second graphical interface with which the device of FIG. 1 interacts;

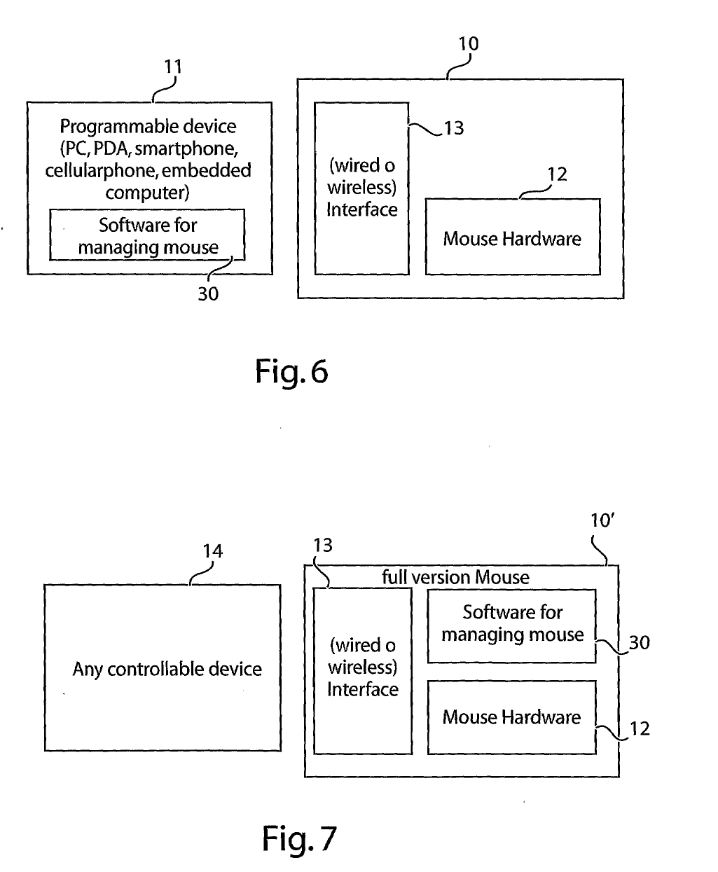

FIG. 6 schematically shows the architecture of a first application of the device according to the invention; and

FIG. 7 schematically shows the architecture of a second application of the device according to the invention.

In the following of the description same references will be used to indicate alike elements in the Figures.

Moreover, in the following of the description reference will be mainly made to the case where the computer is a common computer or a similar electronic apparatus, but it should be understood that the device according to the invention is also applicable to the case where the computer is integrated into a different apparatus, such as for instance an interfaceable electronic or electromechanical apparatus, such as for instance white goods.

With reference to FIGS. 1 and 2, the preferred embodiment of the interactive device according to the invention comprises a thimble shaped disc 1 which two-directionally slides on a tablet 2. In particular, the disc 1 is constrained to the tablet 2 with at least two degrees of freedom, so as to be able to move on a surface included within the same tablet.

To this end, the disc 1 is slidable along two sliding bars, respectively horizontal 3 and vertical 4, which detect movement of the disc 1 by means of respective sensorised side racks operating as means for sensing the position of the same disc 1 within the tablet 2. Preferably, each sliding bar is provided with a respective pair of racks (not shown) orthogonal to it, located at the edges of the surface of the tablet 2 on which the disc 1 moves; in particular, for the horizontal bar 3 the racks are located at the vertical edges 5 and 6 of the tablet 2, while for the vertical bar 4 the racks are located at the horizontal edges 7 and 8 of the tablet 2, so that the horizontal bar 3 and the vertical bar 4 may slide, respectively, vertically and horizontally along the respective pairs of racks. In other words, the system of the two bars 3 and 4 implement a sort of drafting machine mechanism.

With respect to the tablet 2, the disc 1 is in the same relative position as the graphical pointer, controlled by the device according to the invention, is with respect to the computer display: for instance, if the disc 1 is at the top right vertex of the tablet 2, the graphical pointer is at the top right vertex of the display; if the disc 1 is at the centre of the tablet 2, the graphical pointer is at the centre of the display; if the disc 1 is at the bottom left vertex of the tablet 2, the graphical pointer is at the bottom left vertex of the tablet 2. In other words, a one-to-one relationship exists between the position of the disc 1 within the tablet 2 and the position of the controlled graphical pointer on the display. To this end, the surface of the tablet 2 within which the disc 1 moves has the same proportion of the computer display within which the graphical pointer controlled by the device according to the invention moves.

Moreover, the disc 1 of the device of FIGS. 1 and 2 has a third degree of freedom, whereby it may move in a direction orthogonal to the plane of the tablet 2, rising and/or dropping with respect to a rest level. To this end, the disc 1 is provided with a vertical move actuator (not shown), integrally coupled to the disc 1 under the same. Preferably, such actuator is a multiple-state one, since, as it will be described later, the number of levels different from the rest one, to which it may be necessary to bring the disc 1, may be larger than 2. Alternatively, or in addition, the tablet 2 may be subdivided into small areas, each one of which is provided with a corresponding (multiple-state) vertical move actuator.

Preferably, the disc 1 is further provided with vibrating means (not shown) integrally coupled thereto, such as for instance a vibrating reed or a different vibration actuator.

Still, the device of FIGS. 1 and 2 comprises an incorporated acoustic signaler and/or an incorporated speech synthesizer (not shown).

Furthermore, the device of FIGS. 1 and 2 comprises one or more buttons (not shown), preferably located in proximity of the lower horizontal edge 7 of the tablet 2 of FIG. 1, the functionalities of which are similar to those of the buttons of conventional pointing devices, such as mouses, touchpads, and trackballs. Alternatively, the buttons could be wired or wireless connected to the tablet, for instance through infrared or radiofrequency connection. Advantageously, at least one button may be integrated into the same disc 1. Each button is provided, as known to the skilled men in the art, with pressure sensor means. Preferably, the button functionalities are user configurable.

Still, the device of FIGS. 1 and 2 comprises an assembly of electromagnets (not shown), integrally coupled to the disc 1 under the same, capable to exert small forces on the same disc 1 in any direction parallel to the surface of the tablet 2. Such forces are capable to cause a rotation and/or a translation of the disc 1, unless a light opposite force (e.g. exerted by user) resists them.

Moreover, the disc 1 of the device of FIGS. 1 and 2 may further rotate around its own axis, the disc 1 having a preferably raised indicator 9 of the pointing direction and/or of the rotation made by the controlled graphical pointer. To this end, the disc 1 is provided with a rotation sensor (not shown), capable to detect the rotation made by the disc 1 with respect to a reference orientation, and a rotation actuator (still not shown). Such rotation functionality is useful, for instance, in case of handling of images or objects within the graphical interface of a two-dimensional or three-dimensional CAD, wherein the device allows user to rotate images and objects through a corresponding rotation of the disc 1. Moreover, the rotation actuator is useful for automatically imposing a rotation to the disc 1, for instance in some operation modes which will be described later. The rotation functionality of the disc 1 is preferably user configurable.

Preferably, size of tablet 2 is includable in a hand palm. In this regard, minimizing size of tablet 2 allows both a (whether blind or not) user to hold it within a hand palm, and the device according to the invention to be incorporated within computers, such as portable computers and handhelds.

In order to better understand the present invention the operating modes of the preferred embodiment of the pointing device will be described in the following, similar modes being valid for other embodiments.

A user moves the disc 1, preferably by means of a hand finger, on the tablet 2, and the corresponding movement of the disc 1 causes movement of the graphical pointer on the display, according to the aforementioned one-to-one relationship.

When the graphical pointer on the display overlaps any selectable graphical element, the disc 1 vibrates and possibly rises (or drops) to a second level, higher (or lower) than the rest level, preferably by 1-2 mm, more preferably by a configurable height (or depth). Moreover, the incorporated acoustic signaler (if any) emits a warning sound for the user, while the incorporated speech synthesizer (if any) synthesizes a speech description of the selectable graphical element on which the graphical pointer is located; this is particularly advantageous for a visually-impaired or blind user, since it allows such very high interaction to approach the condition of a non impaired user: tactile signal (e.g., the one received through vibration) makes position of the selectable graphical element on the display be “seen”, while synthesized acoustic signal replaces icon image and describes content of the corresponding clickable object.

By way of example, but not by way of limitation, such selectable graphical elements may be command menu bars, window scrolling bars, graphical buttons, selectable option boxes or checkboxes, groups of alternatively selectable option boxes, groups of simultaneously selectable option boxes, textboxes, hypertext connections or links, icons.

As it is already provided in present pointing devices, the effective selection of a selectable graphical element occurs by pressing one of the buttons with which the device according to the invention is provided when the graphical pointer is located over the same element. Advantageously, when a button is integrated into the same disc 1, pressing it may consist in disc dropping on the rest level, if it is configured so as to rise when it overlaps a selectable graphical element, (or pressing it may consist in disc dropping down to a further third level, lower than the second one, if it is configured so as to drop down to the latter when it overlaps a selectable graphical element); in any case, once external pressure exerted by user ends, the disc 1 elastically tends to return to the second level, that is above (or under) the rest level, until the graphical pointer remains superimposed to the selectable graphical element.

Preferably, the height of the second level with respect to the rest one, wherein the disc 1 goes when the graphical pointer controlled by it overlaps a selectable graphical element, is configurable by a user, who may hence choose that the second level is higher or lower than the rest one, and consequently that the disc I rises or drops when it overlaps a selectable graphical element.

The preferred embodiment of the device according to the invention operates in a way similar to the method for moving a graphical pointer on a work area of a computer display described by the Italian Patent No. 1323126, herein incorporated by reference. Namely, such method of moving, that is advantageous when the work area of the computer display comprises one or more selectable graphical elements, provides that the graphical pointer controlled by the disc 1 moves on the work area of the computer display no more in a passive way, i.e. by strictly following movements of the disc 1 on the tablet 2, instead it actively and automatically “couples” to the selectable graphical element that is closer, after a movement of the disc 1 that did not end exactly on the same selectable graphical element, and this happens to both non impaired users (most of all in case of touchpads, trackpoints or simply dirty mouses), and visually or motion impaired users. The “active” method for moving the disc 1 allows the user, when he/she begins to move the disc 1, to be guided towards the closer selectable graphical elements thanks to the micro-forces induced by the assembly of electromagnets and to the rotation imposed to the disc 1 by the rotation actuator, which indicate the presence of selectable graphical elements in the proximity, by attracting the disc 1 just in direction of the closer selectable graphical element. When the user consents to these micro-forces, the disc 1 is guided towards the location on the tablet 2 corresponding to the location of the graphical pointer at which it is exactly superimposed to the selectable graphical element closer to the direction of movement initially made by the user, and at this point the device gives to the user a double signaling: an acoustic one (from signaler and/or synthesizer) and the vibration of the disc 1 as described above. Consequently, the selectable graphical elements are a sort of gravitational “attractors”.

In this regard, still other embodiments of the pointing device according to the invention may comprise means for actuating a movement of the disc 1 different from the assembly of electromagnets previously illustrated. For instance, the assembly of electromagnets may be integrally coupled to one or more edges out of edges 5, 6, 7, and 8 of the tablet 2 of FIGS. 1 and 2, instead of being integrally coupled to the disc 1. Alternatively, the sensorised rack system may be further provided with suitable actuators capable to move the disc 1.

Moreover, alternatively or in combination with the sensorised rack system, other embodiments of the device according to the invention may comprise different means for sensing the position of the same disc 1 within the tablet 2. By way of example, but not by way of limitation, in a way similar to present mouses, the disc 1 could be provided with a ball rolling over a surface of the tablet 2 and cooperating with corresponding movement sensors, or it could be provided with optical and/or laser sensors capable to detect the movement of the disc 1 on the surface of the tablet 2. Furthermore, the means for sensing the position of the disc 1 could comprise sensors, integrally coupled to the disc 1, which read on the tablet 2 the absolute position thereof; this could be implemented, for instance, with color micro-indicators or micro-bar codes or color shade on the tablet 2, thus obtaining a much lighter disc 1.

Preferably, the device according to the invention, whatever means for sensing the position of the disc 1 it is provided with, comprises specific sensors of stop of the disc 1 which, when the disc 1 reaches one of the four edges 5, 6, 7, and 8 of the tablet 2, automatically reset the position of the graphical pointer, locating it at the corresponding edge of the display. Such stop sensors may be simple sensors of the contact of the disc 1 with the edges. Other embodiments may provide that, when the disc 1 reaches one of the four edges 5, 6, 7, and 8 of the tablet 2, the acoustic signaler and/or the speech synthesizer warn the user on such situation.

Advantageously, further embodiments of the pointing device according to the invention provide that the speech synthesizer with which they are provided acoustically gives also text contents, besides the description of the selectable graphical elements, possibly pointed by the graphical pointer. By way of example, but not by way of limitation, such text contents may comprise web pages of Internet sites, text files (such as Microsoft® Winword or others) subdivided into paragraphs or sections, spreadsheet files (such as Microsoft® Excel or others) at the level of cells or cell blocks. In particular, the speech synthesizer of web contents operates according to a text content reader and synthesizer.

As said before, the size of the tablet 2 must be minimized ensuring a pointing resolution; in this regard, the pointing resolution is the number of single points that the device may discriminate per centimetre or inch (1 inch=2, 54 cm). The most used measurement unit is the DPI (Dot Per Inch). With recent mouses, the basic optical or mechanical technology of which may be used, very high and even low cost resolutions are available. It is possible to have a (even optical) mouse having 400 DPI by less than 10 Euros. This means that it is possible to implement a low cost pointing system resolving 400 points per inch, i.e. beyond 150 points per centimetre. This means that, by using the typical resolution today present in portable computers, i.e. 1024*768, the size of the tablet 2 are equal to 6,5*4,9 cm. Today, more sophisticated pointing technologies allows to arrive at resolutions beyond 2000 DPI; consequently, the size of the tablet 2 may be reduced by a fifth through using less inexpensive systems having better performance.

Obviously, the device according to the invention must be able to operate at the several video resolutions configurable on computers. Nearly all the several video resolutions have the same abscissa/ordinate ratio, i.e. 1,(3). Typical examples of video resolutions are:
640*480: ratio=1,333;
800*600: ratio=1,333;
1024*768: ratio=1,333;
1280*960: ratio=1,333; and
1600*1200: ratio=1,333.

One of the few standard resolutions not having the aforesaid X/Y ratio is 1280*1024 resolution, that has ratio=1,25. For this particular resolution, the device may provide that the disc 1 is not active-within the portion of the tablet 2 exceeding the useful area given by this ratio, or even it may provide that such portion is at a different, preferably risen, height with respect to the rest of the surface of the tablet 2 on which the disc 1 moves.

FIG. 3 schematically shows the architecture of the preferred embodiment of the device according to the invention. In particular, the device according to the invention comprises a processing unit 30, connected to a sensor unit 31, comprising the previously illustrated means for sensing the position of the disc 1, means for sensing the rotation of the disc 1, means for sensing the pressure on the buttons, and means for sensing the stop of the disc 1. The processing unit 30 is further connected to a actuator unit 32, comprising the previously illustrated means for actuating the movement of the disc 1 within the tablet 2, means for actuating the vertical movement of the disc 1, means for actuating the vibration of the disc 1, and means for actuating the rotation of the disc 1. Finally, the processing unit 30 is further connected to an acoustic signaler 33 and to a speech synthesizer 34. The processing unit 30 operates according a method, software implemented, capable to process the signals coming from the sensor unit 31 and data related to the position of the controlled graphical pointer and of the graphical interface within which this moves (coming from processing means that controls the display, possibly integrated into unit 30), and to consequently control the actuator unit 32, the acoustic signaler 33, and the speech synthesizer 34, for instance by operating the electromagnet assembly with which the device 10 is provided so as to attract the disc 1 towards the position on the tablet 2 corresponding to that on the display of the computer 10 at which the selectable graphical element, if any, closer to the graphical pointer controlled by the device 10 is.

Preferably, the software implementing the method according to which the processing unit 30 operates, driving the device according to the invention, is a so-called “middleware”, that interfaces the device with the operating system and with the most diffused applications. In particular, such middleware software allows to enable high added value services.

By way of example, but not by way of limitation, by means of it, the device according to the invention may be configured so as to allow a user, in particular a visually impaired or blind user, to advancedly use standard applications such as MS® Word and MS® Excel in an extremely facilitated way.

Namely, in case of a use of MS® Word, such middleware software may easily allow to read a line/paragraph/section of a text document in a guided manner. The user is able to make it by simply locating the disc 1 at the position on the tablet 2 corresponding to the position of starting of the same document (this in particular thanks to the forces applied to the disc 1 by the actuators of the unit 32 suitably controlled by the processing unit 30) and by stressing the disc 1 with a slight right movement, as represented by A arrow of FIG. 4. This indication is interpreted by the middleware software as a will to start reading the line/paragraph/section of the text document.

Similarly, in case of a use of MS® Excel, if the user wishes to read a column of a table, it is sufficient that he/she locates the disc 1 (still guided thanks to the forces applied to the disc 1 by the actuators of the unit 32 suitably controlled by the processing unit 30) at the position on the tablet 2 corresponding to the beginning of the table, he/she horizontally scrolls until the column of interest (found by reading the several heading cells of the various columns by means of the synthesizer) and stresses the disc 1 with a slight downward movement, as represented by B arrow of FIG. 5. This indication is interpreted by the middleware software as a will to start reading the column.

In this way, it is possible to give text contents of sections displayed on the display, such as for instance text documents accessible at level of lines/paragraphs/sections, or spreadsheets accessible at level of cells or cell blocks.

Advantageously, the middleware software allows to interface the device according to the invention with most common softwares, such as, by way of example but not by way of limitation, MS® Windows Xp, MS® Windows Media Center operating systems, softwares of text processing, of email managing, spreadsheets, DBMS, CRM.

There are many applications of the pointing device according to the invention.

First of all, it may be used as peripheral pointing unit for computers (on the display of which it controls a graphical pointer), such as for instance fixed computers, portable computers, cellular telephones, personal digital assistant, and handhelds. By way of example, but not by way of limitation, the pointing device may be wired connected (e.g. through serial port, parallel port, USB, firewire) and/or wireless connected (e.g. through wi-fi, bluetooth, wi-max, zigbee) to the computer.

FIG. 6 schematically shows the architecture of such application, wherein the pointing device according to the invention is indicated by reference number 10 and the computer to which it is connected is indicated by reference number 11. In particular, the device 10 comprises hardware 12, including disco, tablet, sensor means and actuator means, and an wired or wireless interface unit 13 for connection to the computer 10. This is provided with processing means 30 (possibly integrated into a main microprocessor of the computer) that controls device 10. In particular, the acoustic signaler 33 and/or the speech synthesizer 34 of FIG. 3 may be integrated into the computer 11.

In the application of FIG. 6, the pointing device according to the invention may be further incorporated in computer 10, e.g. a portable computer, in place of conventional and less efficient trackballs or touchpads.

FIG. 7 shows a second possible application of the device 10′ according to the invention, wherein the processing and control means 30, preferably programmable, are incorporated in the same device 10′. Through the interface unit 13, the device 10′ controls any interfaceable electronic or electromechanical apparatus 14, such as, for instance, white goods, according to the most recent interconnection standards, e.g. ISO or W3C one for domotics.

The advantages offered by the device according to the invention are evident.

First of all, it allows in a simple, precise, and reliable way the movement of a graphical pointer within a work area of a computer display.

Moreover, the device according to the invention ensures a greater user interaction.

Finally, it is particularly advantageous for blind or visually impaired users, making the use of a computer, such as a common computer, easier, for instance for accessing to the Internet.

The preferred embodiments have been above described and some modifications of this invention have been suggested, but it should be understood that those skilled in the art can make variations and changes, without so departing from the related scope of protection, as defined by the following claims.

1. 1. A device for controlling at least one graphical pointer on a work area of a computer display, comprising at least one element, corresponding to said at least one graphical pointer, capable to move on an area included in a tablet, and sensor means capable to detect the position of said at least one element in said area of the tablet, a one-to-one relationship existing between the position of said at least one element within said area of the tablet and the position of said at least one graphical pointer on said work area of the display, wherein said at least one element is movable by means of motion means according to at least two degrees of freedom with respect to the tablet, the means for sensing the position of said at least one element sending one or more signals to processing means capable to process them for determining the position of said at least one graphical pointer corresponding one-to-one with the position of said at least one element the device further comprises means for actuating a movement of said at least one element in said area of the tablet, controlled by the processing means, wherein the processing means receives from the computer data related to said work area of the computer display, and activates the means for actuating a movement of said at least one element in said area of the tablet so as to move said at least one element towards a target position, internal to an attraction area included within said area of the tablet, corresponding to the position of the selectable graphical element, if any, internal to an attraction zone of said work area of the display, corresponding to said attraction area, and that is the closest to the current position of the graphical pointer according to a geometric proximity criterion.

2-72. (canceled)

73. A device according to claim 1, wherein the processing means activates the means for actuating a movement of said at least one element in said area of the tablet
either at the end of a time period during which said at least one element has remained stable in a fixed position, said attraction zone of said work area of the display being preferably centered on the position of the graphical pointer corresponding to said fixed position of said at least one element, or
when said at least one element has made an initial movement longer than a minimum threshold starting from a starting position.

74. A device according to claim 1, wherein the means for actuating a movement of said at least one element in said area of the tablet comprises one or more electromagnets, preferably integrally coupled to said at least one element and/or to said tablet.

75. A device according to claim 1, wherein said at least one element is capable to rotate around a related axis, and wherein the device comprises means for sensing the rotation of said at least one element around to said axis that sends one or more signals to the processing means capable to process them for determining an orientation of said at least one element, said at least one element preferably comprising means for indicating the orientation of said at least one element.

76. A device according to claim 75, wherein it further comprises means for actuating a rotation of said at least one element around a related axis, controlled by the processing means.

77. A device according to claim 76, wherein the processing means receives from the computer data related to said work area of the computer display, and activates the means for actuating a rotation of said at least one element so as to rotate said at least one element for orientating it towards said target position.

78. A device according to claim 77, wherein the processing means activates the means for actuating a rotation of said at least one element
either at the end of a time period during which said at least one element has remained stable in a fixed position, said attraction zone of said work area of the display being preferably centered on the position of the graphical pointer corresponding to said fixed position of said at least one element, or
when said at least one element has made an initial movement longer than a minimum threshold starting from a starting position.

79. A device according to claim 73, wherein said attraction zone of said work area of the display is symmetrical with respect to the direction of movement of the graphical pointer corresponding to the initial movement of said at least one element.

80. A device according to claim 79, wherein said attraction zone of said work area of the display is included within a plane angle, of value not larger than 180°, preferably not larger than 90°, more preferably not larger than 60°, still more preferably not larger than 45°, the vertex of which is in the initial position of the graphical pointer and the bisector of which lies along the direction of movement of the graphical pointer.

81. A device according to claim 80, wherein said attraction zone of said work area of the display is the intersection of a isosceles triangle or a circular sector or said plane angle with said work area.

82. A device according to claim 78, wherein said attraction zone of said work area of the display is symmetrical with respect to the direction of movement of the graphical pointer corresponding to the initial movement of said at least one element.

83. A device according to claim 82, wherein said attraction zone of said work area of the display is included within a plane angle, of value not larger than 180°, preferably not larger than 90°, more preferably not larger than 60°, still more preferably not larger than 45°, the vertex of which is in the initial position of the graphical pointer and the bisector of which lies along the direction of movement of the graphical pointer.

84. A device according to claim 83, wherein said attraction zone of said work area of the display is the intersection of a isosceles triangle or a circular sector or said plane angle with said work area.

85. A device according to claim 1, wherein it further comprises means for actuating a movement of said at least one element in direction orthogonal to the plane of the tablet, controlled by the processing means so as to move said at least one element to at least one level different from at least one rest level, said at least one different level being at height higher or lower than said at least one rest level with reference to the plane of the tablet, the means for actuating a movement of said at least one element in direction orthogonal to the plane of the tablet being preferably integrally coupled to said at least one element, wherein the tablet is more preferably subdivided into one or more small areas and the means for actuating a movement of said at least one element in direction orthogonal to the plane of the tablet, wherein the latter still more preferably comprises one or more actuators each one of which is integrally coupled to a corresponding small area and is capable to move it in direction orthogonal to the plane of the tablet, wherein the processing means even more preferably receives from the computer data related to said work area of the computer display and activates the means for actuating a movement of said at least one element in direction orthogonal to the plane of the tablet when this is on a position of said area of the tablet corresponding to a position of the graphical pointer superimposed to a selectable graphical element of said work area.

86. A device according to claim 1, wherein the processing means receives from the computer data related to said work area of the computer display, and activates speech synthesizer means when said at least one element is in a position of said area of the tablet corresponding to a position of the graphical pointer superimposed to a selectable graphical element of said work area, so as to preferably play a description of said selectable graphical element of said work area, wherein said speech synthesizer means is preferably incorporated in either the device or said computer.

87. A device according to claim 1, wherein, when the processing means receives from the computer one or more signals indicative of the fact that the graphical pointer is superimposed to a zone of said work area comprising at least one text content, the processing means activates speech synthesizer means so as to play said at least one text content.

88. A device according to claim 1, wherein said at least one element comprises a disc, preferably thimble-shaped.

89. A device according to claim 1, wherein the means for sensing the position of said at least one element comprises optical and/or laser sensor means capable to detect the movement of said at least one element on said area of the tablet.

90. A device according to claim 1, wherein it further comprises one or more buttons, each one of which is capable to send to the processing means at least one corresponding selection signal when it is pressed, at least one button being preferably integrated into said at least one element.

91. A device according to claim 1, wherein the processing means receives from the computer data related to said work area of the computer display, and activates acoustic signaling means, preferably incorporated in either the device or said computer, when said at least one element is in a position of said area of the tablet corresponding to a position of the graphical pointer superimposed to a selectable graphical element of said work area.

92. A method for controlling at least one graphical pointer on a work area of a computer display, wherein said at least one graphical pointer is controlled by a device comprising at least one element, corresponding to said at least one graphical pointer, capable to move on an area included in a tablet, and sensor means capable to detect the position of said at least one element in said area of the tablet, a one-to-one relationship existing between the position of said at least one element within said area of the tablet and the position of said at least one graphical pointer on said work area of the display, wherein said at least one element is movable by means of motion means according to at least two degrees of freedom with respect to the tablet, the device further comprising means for actuating a movement of said at least one element in said area of the tablet, controlled by the processing means, wherein the processing means receives from the computer data related to said work area of the computer display, wherein the method comprises the following steps:
A. receiving, from said sensor means, one or more first signals indicative of the position of said at least one element in said area of the tablet;
B. processing said one or more first signals for determining the position of said at least one graphical pointer corresponding one-to-one with the position of said at least one element;
K. activating said means for actuating a movement of said at least one element in said area of the tablet, so as to move said at least one element towards a target position, internal to an attraction area included in said area of the tablet, corresponding to the position of the selectable graphical element, if any, internal to an attraction zone of said work area of the display, corresponding to said attraction area, and that is closest to the current position of the graphical pointer according to a geometric proximity criterion.

93. A method according to claim 92, wherein step K is executed
either at the end of a time period during which said at least one element has remained stable in a fixed position, said attraction zone of said work area of the display being preferably centered on the position of the graphical pointer corresponding to said fixed position of said at least one element, or
when said at least one element has made an initial movement longer than a minimum threshold starting from a starting position.

94. A method according to claim 92, wherein, when said at least one element is in a position of said area of the tablet corresponding to a position of the graphical pointer superimposed to a zone of said work area comprising at least one text content, said selectable graphical element closest to the current position of the graphical pointer is a point of said zone comprising said at least one text content, preferably the initial point of said at least one text content.

95. A method according to claim 92, wherein said at least one element is capable to rotate around a related axis, the device comprising means for sensing the rotation of said at least one element around to said axis, said at least one element preferably comprising means for indicating the orientation of said at least one element, and wherein the method further comprises the following steps:
M. receiving, from the means for sensing the rotation, one or more third signals indicative of the rotation of said at least one element around said axis;
N. determining the orientation of said at least one element.

96. A method according to claim 92, wherein said device further comprises means for actuating a rotation of said at least one element around a related axis, controlled by the processing means, and the method further comprises the following step:
P. activating said means for actuating a rotation of said at least one element around a related axis, so as to orientate it towards said target position.

97. A method according to claim 96, wherein step P is executed
either at the end of a time period during which said at least one element has remained stable in a fixed position, said attraction zone of said work area of the display being preferably centered on the position of the graphical pointer corresponding to said fixed position of said at least one element, or
when said at least one element has made an initial movement longer than a minimum threshold starting from a starting position.

98. A method according to claim 93, wherein said attraction zone of said work area of the display is symmetrical with respect to the direction of movement of the graphical pointer corresponding to the initial movement of said at least one element.

99. A method according to claim 98, wherein said attraction zone of said work area of the display is included within a plane angle, of value not larger than 180°, preferably not larger than 90°, more preferably not larger than 60°, still more preferably not larger than 45°, the vertex of which is in the initial position of the graphical pointer and the bisector of which lies along the direction of movement of the graphical pointer.

100. A method according to claim 99, wherein said attraction zone of said work area of the display is the intersection of a isosceles triangle or a circular sector or said plane angle with said work area.

101. A method according to claim 97, wherein said attraction zone of said work area of the display is symmetrical with respect to the direction of movement of the graphical pointer corresponding to the initial movement of said at least one element.

102. A method according to claim 101, wherein said attraction zone of said work area of the display is included within a plane angle, of value not larger than 180°, preferably not larger than 90°, more preferably not larger than 60°, still more preferably not larger than 45°, the vertex of which is in the initial position of the graphical pointer and the bisector of which lies along the direction of movement of the graphical pointer.

103. A method according to claim 102, wherein said attraction zone of said work area of the display is the intersection of a isosceles triangle or a circular sector or said plane angle with said work area.

104. A method according to claim 92, wherein said device further comprises means for actuating a movement of said at least one element in direction orthogonal to the plane of the tablet, controlled by the processing means, and the method further comprises the following step:
E. controlling said means for actuating a movement of said at least one element in direction orthogonal to the plane of the tablet, so as to move said at least one element to said at least one level different from said at least one rest level,
that is preferably executed when said at least one element is in a position of said area of the tablet corresponding to a position of the graphical pointer superimposed to a selectable graphical element of said work area.

105. A method according to claim 92, wherein the processing means of said device is capable to activate speech synthesizer means, and the method further comprises the following step:
H. activating said speech synthesizer means when said at least one element is in a position of said area of the tablet corresponding to a position of the graphical pointer superimposed to a selectable graphical element of said work area, so as to preferably play a description of said selectable graphical element of said work area.

106. Method according to claim 105, wherein it further comprises the following step:
J. activating said speech synthesizer means when said at least one element is in a position of said area of the tablet corresponding to a position of the graphical pointer superimposed to a zone of said work area comprising at least one text content, so as to play said at least one text content.

107. A method according to claim 92, wherein the processing means of said device is capable to activate acoustic signaling means, and the method further comprises the following step:
G. activating said acoustic signaling means when said at least one element is in a position of said area of the tablet corresponding to a position of the graphical pointer superimposed to a selectable graphical element of said work area.

108. A computer, wherein it incorporates a device for controlling at least one graphical pointer on a work area of a computer display, comprising at least one element, corresponding to said at least one graphical pointer, capable to move on an area included in a tablet, and sensor means capable to detect the position of said at least one element in said area of the tablet, a one-to-one relationship existing between the position of said at least one element within said area of the tablet and the position of said at least one graphical pointer on said work area of the display, wherein said at least one element is movable by means of motion means according to at least two degrees of freedom with respect to the tablet, the means for sensing the position of said at least one element sending one or more signals to processing means capable to process them for determining the position of said at least one graphical pointer corresponding one-to-one with the position of said at least one element, the device further comprises means for actuating a movement of said at least one element in said area of the tablet, controlled by the processing means, wherein the processing means receives from the computer data related to said work area of the computer display, and activates the means for actuating a movement of said at least one element in said area of the tablet so as to move said at least one element towards a target position, internal to an attraction area included within said area of the tablet, corresponding to the position of the selectable graphical element, if any, internal to an attraction zone of said work area of the display, corresponding to said attraction area, and that is the closest to the current position of the graphical pointer according to a geometric proximity criterion.
